(19) United States
(12) Patent Application Publication
(10) Pub. No.: US 2010/0064125 A1
(43) Pub. Date: Mar. 11, 2010

(54) PROGRAMMABLE DEVICE AND BOOTING METHOD

(75) Inventors: Meng-Chang LIU, Taipei Hsien (TW); Jen-Ming TSAO, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/208,539

(22) Filed: Sep. 11, 2008

(51) Int. Cl. G06F 15/177; G06F 21/00

(52) U.S. Cl. 713/2; 713/189

(57) ABSTRACT

A programmable device is provided, comprising a memory for storage of an encrypted boot loader, and a processing unit coupled to the memory. In the processing unit, a boot straper decrypts the encrypted boot loader into a plurality of boot loader instructions when the programmable device is initialized. A core executes boot loader instructions to accordingly load and execute an operation system.

### BACKGROUND OF THE INVENTION

1. Field of the Invention

The invention relates to booting methods, and in particular, to a method for executing an encrypted boot loader.

2. Description of the Related Art

Conventionally, an embedded system such as a programmable device is controlled by firmware, and the firmware may also be referred to as an operation system (OS) designated to provide various functionalities on the programmable device. The firmware is generally stored in a Read Only Memory (ROM) within the programmable device. To protect the programmable device from eavesdropping, the operation system in the ROM is in an encrypted form. To initialize the operation system, a boot loader is provided as an executable code stream comprising essential parameters required by system hardware. The boot loader may be first loaded upon system start up (initialization), and a core then executes the boot loader instructions to initialize system hardware, thereby initializing the operation system.

The operation system may be protected by encryption, however, the boot loader must be in a plaintext form because the core can not interpret and execute an encrypted code. Thus, the boot loader is vulnerable from eavesdropping, and essential information to decipher the operation system may still be compromised. It is therefore desirable to provide an enhanced structure for securing the firmware.

### BRIEF SUMMARY OF THE INVENTION

A detailed description is given in the following embodiments with reference to the accompanying drawings.

An exemplary embodiment of a programmable device is provided, comprising a memory for storage of an encrypted boot loader, and a processing unit coupled to the ROM. In the processing unit, a boot straper decrypts the encrypted boot loader into a plurality of boot loader instructions when the programmable device is initialized. A core executes boot loader instructions to accordingly load and execute an operation system.

Another embodiment provides a booting method implemented on the programmable device. First, the encrypted boot loader is decrypted into boot loader instructions when the programmable device is initialized. Thereafter, the boot loader instructions are executed to accordingly load and execute an operation system.

### BRIEF DESCRIPTION OF THE DRAWINGS

The invention can be more fully understood by reading the subsequent detailed description and examples with references made to the accompanying drawings, wherein:

FIG. 1 shows an embodiment of a programmable device;

FIGS. 2a, 2b and 2c are flowcharts of the booting method according to the invention; and

FIG. 3 shows an embodiment of a decryption process.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

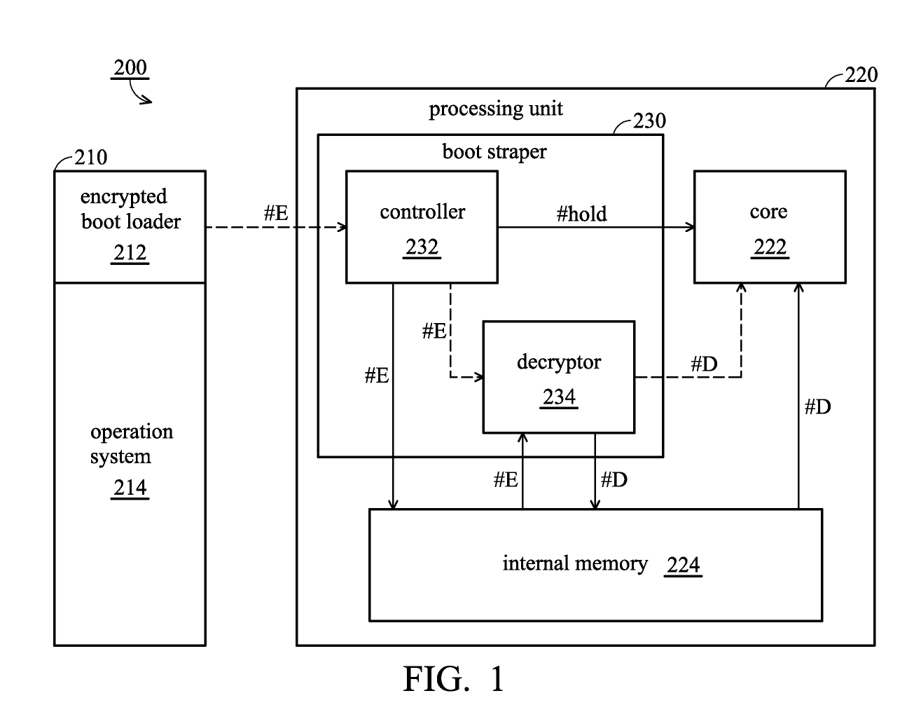

FIG. 1 shows an embodiment of a programmable device 200 comprising a Read Only Memory (ROM) 210 and a processing unit 220. In the memory 210, an encrypted boot loader 212 comprising an executable code stream in cipher text is provided for obtaining essential parameters in power-on procedure. Please note that the memory 210 is a non-volatile memory such as Read Only Memory (ROM) and flash memory. A processing unit 220 is coupled to the memory 210, comprising a boot straper 230 dedicated to decrypt the encrypted boot loader 212. When the programmable device 200 is powered up, the boot straper 230 fetches the encrypted boot loader 212 from the memory 210 and stores the fetched encrypted boot loader 212 in an internal memory 224. The boot straper 230 then decrypts the encrypted boot loader 212 into boot loader instructions #D which may be stored in the internal memory 224. The core 222 then fetches and executes boot loader instructions #D to initialize system environments. Thereby, an operation system 214 may be accordingly loaded and executed.

The encrypted boot loader 212 is transmitted to the boot straper 230 as a plurality of encrypted codes #E. The boot straper 230 sequentially decrypts the encrypted codes #E to acquire a plurality of boot loader instructions #D executable by the core 222. In an embodiment, the encrypted boot loader 212 comprises customized parameters for executing the operation system 214, such as privilege information, file system information, partition and root directory configuration, and device driver tuning parameters. Furthermore, the operation system 214 may be stored in the memory 210 or other external memories, and the encrypted boot loader 212 must include an entry point indicating where to load the operation system 214. In the embodiment, the encrypted boot loader 212 is encrypted, thus the information contained in the encrypted boot loader 212 can be protected from eavesdropping. As described, the operation system 214 is usually in an encrypted form, thus, an algorithm or a key can be defined in the encrypted boot loader 212 or embedded inside the chip for decrypting the operation system 214 into an executable form.

As shown in FIG. 1, the encrypted codes #E and boot loader instructions #D are represented in various data paths, depending on different execution approaches. The boot straper 230 mainly comprises a controller 232 and a decryptor 234. The controller 232 is designated to control data flows between the memory 210 and the core 222. The decryptor 234 is a circuit controlled by the controller 232 for decrypting the encrypted codes #E to generate the boot loader instructions #D. In the embodiment, the encryption format of the encrypted boot loader 212 and the algorithm for decryption is not limited. However, to reduce cost and computation power, the encryption and decryption can be as simple as merely byte scrambling/interleaving, thus the decryptor 234 can be implemented as a simple descrambling/deinterleaving circuit.

The internal memory 224 may be used as a buffer for storing the encrypted codes #E before the decryptor 234 performs the decryption, and a buffer for storing the boot loader instructions #D before they are executed by the core 222. When the programmable device 200 is initialized or powered up, the controller 232 asserts a hold signal #hold to prevent the core 222 from fetching and executing instructions. As an alternative approach, the hold signal #hold may modify a program counter of the core 222 to cause the core 222 halted. Decryption of the encrypted boot loader 212 is performed during the suspension of the core 222. The controller 232 first consequently fetches the encrypted codes #E from the memory 210 to buffer in the internal memory 224, and the decryptor 234 then reads the internal memory 224 to decrypt the encrypted codes #E into the boot loader instructions #D.

When the boot loader instructions #D are generated by the decryptor 234, the boot loader instructions #D are buffered in the internal memory 224, available for the core 222 to execute. At this instance, the controller 232 de-asserts the hold signal #hold, such that the core 222 is enabled to fetch and execute the boot loader instructions #D from the internal memory 224.

In an alternative embodiment, the decryptor 234 may directly output the boot loader instructions #D to the core 222 instead of buffering in the internal memory 224. In this case, when the decryptor 234 decrypts the boot loader instructions #D, the controller 232 de-asserts the hold signal #hold, such that the core 222 directly fetches the decrypted boot loader instructions #D from the decryptor 234 to execute.

In an alternative embodiment, the controller 232 does not buffer the encrypted codes #E read from the memory 210 into the internal memory 224 after the core 222 is halted. To the contrary, the controller 232 directly passes the encrypted codes #E from the memory 210 to the decryptor 234 (doted line #E), and the decryptor 234 simultaneously decrypts the encrypted codes #E into the boot loader instructions #D. As described, the output of decryptor 234 has two alternative data paths. The boot loader instructions #D may be buffered in the internal memory 224, or directly sent to the core 222 (doted line #D). If the controller 232, decryptor 234 and core 222 simultaneously function as a pipeline to directly provide the boot loader instructions #D to the core 222 (dotted line data paths #E and #D), it would not be necessary to hold the core 222, and the hold signal #hold may not be necessary in this case.

The embodiment of programmable device 200 is particularly adaptable for a compact disc (CD) ROM device, a digital versatile device (DVD) ROM or a Blu-ray device. However, any firmware based devices may also be applicable.

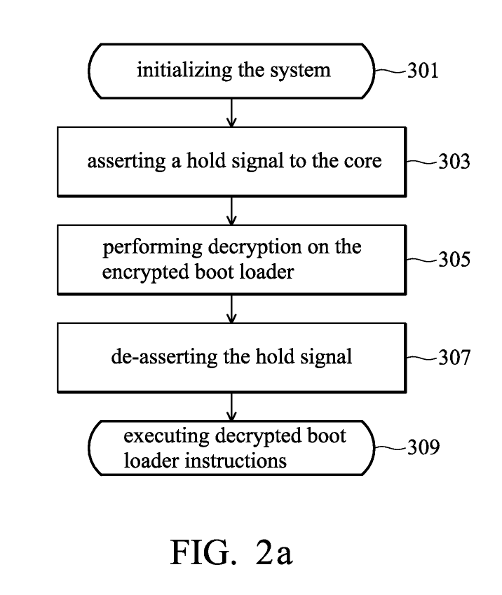

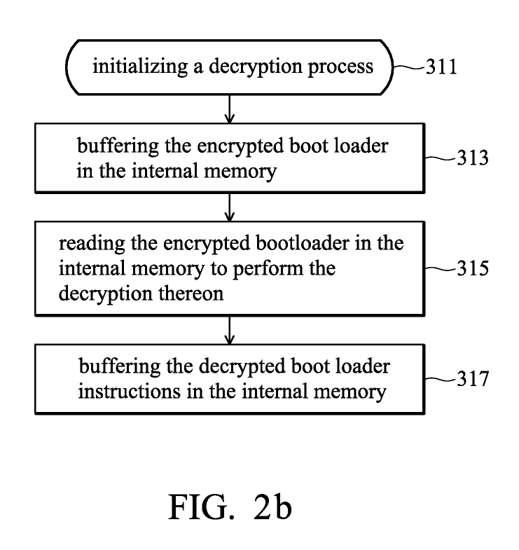

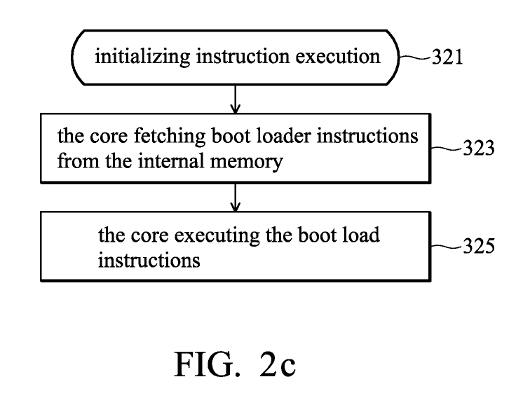

FIGS. 2a, 2b and 2c are flowcharts of the booting method according to embodiments of the invention. In FIG. 2a, a booting method is described. In step 301, the programmable device 200 is powered up. In step 303, the boot straper 230 asserts a hold signal #hold to halt the core 222. In step 305, decryption is performed on the encrypted boot loader 212. In step 307, upon completion of the decryption, the boot straper 230 de-asserts the hold signal #hold. In step 309, the core 222 is able to execute the boot loader instructions #D.

FIG. 2b is a flowchart of a decryption process employing the internal memory 224. In step 311, the decryption process is initialized after the core 222 is halted. In step 313, the encrypted codes #E are buffered to the internal memory 224. In step 315, the decryptor 234 reads the internal memory 224 in the internal memory 224 to decrypt the encrypted codes #E. In step 317, the decryptor 234 stores the boot loader instructions #D decrypted from the encrypted codes #E in the internal memory 224.

FIG. 2c is a flowchart of execution of the boot loader instructions #D. In step 321, the core 222 is un-halt when the decryption is complete. In step 323, the core 222 fetches boot loader instructions #D from the internal memory 224. In step 325, the boot loader instructions #D are executed, and consequently, the operation system 214 can be securely initialized and loaded.

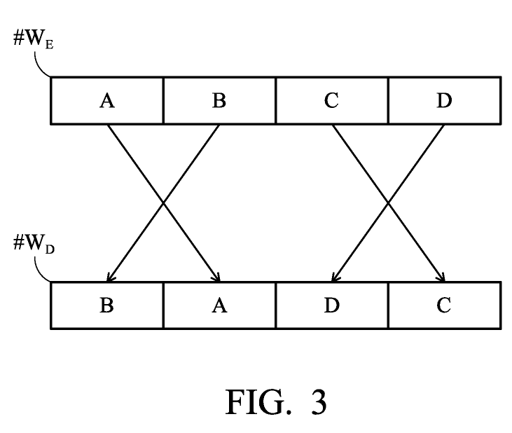

FIG. 3 shows an exemplary embodiment of a decryption process performed by the decryptor 234 on the encrypted codes #E. The codeword #W_{E} shows an example of the encrypted code #E, comprising four portions A, B, C and D in order. Each portion may represent a byte or a word, and the invention does not limit it. The codeword #W_{D} shows a corresponding boot loader instruction #D, which is deinterleaved from the codeword #W_{E}, with portions A and B interchanged, and portions C and D interchanged. In other words, each byte/word in every two bytes/words is interchanged. According to the embodiment, it is intuitive that the encryption can be implemented by various alternative byte scrambling/interleaving approaches to prevent the encrypted boot loader from being eavesdropped, while the encryption/decryption circuit can be made simple and compact. However, the algorithm must be resided in the processing unit 220 where eavesdropping or reverse engineering is difficult.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A programmable device, comprising:
a memory for storage of an encrypted boot loader;
a processing unit coupled to the memory, comprising:
a boot straper, for decrypting the encrypted boot loader into a plurality of boot loader instructions when the programmable device is initialized; and
a core, for executing the boot loader instructions to accordingly load and execute an operation system.

2. The programmable device as claimed in claim 1, wherein the encrypted boot loader comprises a plurality of data bytes, and the boot straper interchanges every two adjacent data bytes to generate the boot loader instructions.

3. The programmable device as claimed in claim 1, wherein the boot loader instructions comprises customized parameters for executing the operation system.

4. The programmable device as claimed in claim 3, wherein the operation system is stored in the memory, and the boot loader instructions comprises an entry pointer indicating where to load the operation system.

5. The programmable device as claimed in claim 3, wherein the operation system is in an encrypted form, and the boot loader instructions further comprises means for decrypting the operation system into an executable form.

6. The programmable device as claimed in claim 1, wherein
the processing unit further comprises an internal memory coupled to the boot straper and the core; and
the boot straper comprises:
a controller, coupled to the memory and the core, for controlling data flows between the memory and the core; and
a decryptor, controlled by the controller to perform decryption on the encrypted boot loader.

7. The programmable device as claimed in claim 6, wherein when the programmable device is initialized:
the controller asserts a hold signal to prevent the core from fetching and executing instructions;
the controller fetches the encrypted boot loader from the memory to buffer in the internal memory; and
the decryptor reads the internal memory to decrypt the encrypted boot loader into the boot loader instructions.

8. The programmable device as claimed in claim 7, wherein:
the decryptor buffers the boot loader instructions in the internal memory; and
the controller de-asserts the hold signal when the boot loader instructions is buffered in the internal memory, such that the core fetches the boot loader instructions from the internal memory to execute.

9. The programmable device as claimed in claim 7, wherein the controller de-asserts the hold signal, such that the core directly fetches the boot loader instructions from the decryptor to execute.

10. The programmable device as claimed in claim 6, wherein when the programmable device is initialized:
the controller asserts a hold signal to prevent the core from fetching and executing instructions;
the controller fetches the encrypted boot loader from the memory to pass to the decryptor;
the decryptor decrypts the encrypted boot loader into the boot loader instructions.

11. The programmable device as claimed in claim 10, wherein:
the decryptor buffers the boot loader instructions in the internal memory; and
the controller de-asserts the hold signal when the boot loader instructions is buffered in the internal memory, such that the core fetches the boot loader instructions from the internal memory to execute.

12. The programmable device as claimed in claim 10, wherein when the decryptor generates the boot loader instructions, the controller de-asserts the hold signal, such that the core directly fetches the boot loader instructions from the decryptor to execute.

13. The programmable device as claimed in claim 1, wherein the programmable device is a compact disc (CD) ROM device, a digital versatile device (DVD) ROM or a Blu-ray device.

14. A booting method comprising:
decrypting an encrypted boot loader into a plurality of boot loader instructions; and
directing a core of a processing unit to execute the boot loader instructions to accordingly load and execute an operation system.

15. The booting method as claimed in claim 14, wherein the encrypted boot loader comprises a plurality of data bytes, and decryption of the encrypted boot loader comprises interchanging every two adjacent data bytes to generate the boot loader instructions.

16. The booting method as claimed in claim 14, wherein the boot loader instructions comprises customized parameters for executing the operation system.

17. The booting method as claimed in claim 14, wherein the boot loader instructions comprises an entry pointer indicating where to load the operation system.

18. The booting method as claimed in claim 14, wherein the operation system is in an encrypted form, and execution of the boot loader instructions comprises, decrypting the operation system into an executable form.

19. The booting method as claimed in claim 14, further comprising:
asserting a hold signal to prevent the core from fetching and executing instructions before decrypting the encrypted boot loader;
buffering the encrypted boot loader in an internal memory of the processing unit before decrypting the encrypted boot loader; and
reading the internal memory to decrypt the encrypted boot loader into the boot loader instructions.

20. The booting method as claimed in claim 19, further comprising:
buffering the boot loader instructions in the internal memory; and
de-asserting the hold signal when the boot loader instructions is buffered in the internal memory, such that the core fetches the boot loader instructions from the internal memory to execute.

21. The booting method as claimed in claim 19, further comprising:
de-asserting the hold signal when the decryptor generates the boot loader instructions, such that the core directly fetches the boot loader instructions from the controller to execute.
